(19) United States
(12) Patent Application Publication
(10) Pub. No.: US 2025/0088867 A1
(43) Pub. Date: Mar. 13, 2025

(54) RANK DRIVEN MEASUREMENT EVENT AND REPORTING

(71) Applicant: Nokia Technologies Oy, Espoo (FI)

(72) Inventors: Samantha CAPORAL DEL BARRIO, Aalborg (DK); Paolo Baracca, Munich (DE); Matha Deghel, Massy (FR); Sami-Jukka Hakola, Oulu (FI)

(21) Appl. No.: 18/823,850

(22) Filed: Sep. 4, 2024

(30) Foreign Application Priority Data
Sep. 11, 2023 (FI) 20236015

(51) Int. Cl. H04W 16/28; H04B 17/309; H04B 17/318; H04W 24/10

(52) U.S. Cl. CPC H04W 16/28; H04B 17/328; H04B 17/346; H04W 24/10

(57) ABSTRACT

Described herein in at least one embodiment is a user equipment (UE), caused to: determine a first rank associated with a first beam set scheduled by one or more network nodes configured in a cell serving the UE for communication between the UE and the one or more network nodes, wherein the first beam set comprises one or more beams; report to the one or more network nodes that a second rank higher than the first rank is achievable by a second beam set, wherein the second beam set comprises one or more beams; and receive from the one or more network nodes a switching command to be scheduled on the reported second beam set instead of the first beam set.

### RELATED APPLICATION

This application claims priority from, and the benefit of, Finland Application No. 20236015, filed on Sep. 11, 2023, the contents of which is incorporated herein by reference in its entirety.

### FIELD

The present disclosure relates to beam management, in particular to UE measurement reporting for beam selection.

### BACKGROUND

Any discussion of the background art throughout the specification should in no way be considered as an admission that such art is widely known or forms part of common general knowledge in the field.

Regarding event-triggered measurement reports for Mobility, 3GPP specification 38.331 specified following events defined for handover in 5G NR:
Event A1 (Serving becomes better than threshold)
Event A2 (Serving becomes worse than threshold)
Event A3 (Neighbor becomes offset better than SpCell)
Event A4 (Neighbor becomes better than threshold)
Event A5 (SpCell becomes worse than threshold1 and neighbor becomes better than threshold2)
Event A6 (Neighbour becomes offset better than SCell)
Event B1 (Inter RAT neighbour becomes better than threshold)
Event B2 (PCell becomes worse than threshold1 and inter RAT neighbor becomes better than threshold2).

As illustrated in FIG. 1, best-beam selection with DL L1-RSRP (Reference Signal Received Power) values per beam does not ensure maximizing the rank, i.e., the number of layers that can be transmitted towards the UE. If there is high correlation among the channels measured at the UE with two (or even more) beams (and that is common, e.g., in Line-of-Sight, LOS, single-ray or single-cluster scenarios) then the UE cannot get high ranks because channel diversity is missing (uncorrelated channel components only in polarization domain possible). In such a case, even if gNB schedules 2 different CSI (Channel State Information) beams with 2-ports on each CSI beam, the UE may only be able to see rank 1 or rank 2 but not the full potential of rank 4.

Hence, there is a need to ensure that the UE selects and obtains a maximum possible rank under a UE-triggered reporting/event context.

### SUMMARY

In accordance with a first aspect of the present disclosure, there is provided a User Equipment, UE, configured to establish communication with one or more network nodes configured in a cell serving the UE, comprising:
at least one processor, and
at least one memory storing instructions that, when executed by the at least one processor, cause the UE at least to:
   determine a first rank associated with a first beam set scheduled by the one or more network nodes for the communication between the UE and the one or more network nodes, wherein the first beam set comprises one or more beams;
   report to the one or more network nodes that a second rank higher than the first rank is achievable by a second beam set, wherein the second beam set comprises one or more beams; and
   receive from the one or more network nodes a switching command to be scheduled on the reported second beam set instead of the first beam set.

In some examples, for a beam set comprising at least two beams, the UE is configured to determine a correlation between the at least two beams comprised in the beam set, wherein a higher correlation between said beams indicates a lower rank associated with said beam set.

In some examples: the first beam set comprises one beam transmitted with two antenna ports, wherein the first rank corresponds to a Rank Indicator, RI, of 2; and the UE is configured to:
indicate the one or more network nodes to transmit a plurality of beam groups each comprising one or more beams for obtaining the second beam set;
receive, from the one or more network nodes, the plurality of beam groups; perform measurement on the beams comprised in the plurality of beam groups; and
determine, among the plurality of beam groups based on the performed measurement, the second beam set associated with the achievable second rank higher than the first rank; and
report to the one or more network nodes the determined second beam set, wherein the reporting is triggered by the UE when the UE determines that the achievable second rank is higher than the first rank.

In some examples:
the UE is configured to measure a Reference Signal Received Power, RSRP, or Signal-to-Interference-plus-Noise Ratio, SINR, value for each beam comprised in the plurality of beam groups, and the measured RSRP/SINR value for each beam is greater than or equal to a first threshold; and/or
the UE is configured to determine a rank associated with each beam group, and for each beam group the determined rank is greater than or equal to a second threshold.

In some examples:
at least one beam group of said plurality of beam groups comprises at least one beam that is said one beam comprised in the first beam set; and/or
for at least one beam group of said plurality of beam groups, the one or more beams comprised in said at least one beam group are all different from said one beam comprised in the first beam set.

In some examples, the number of the one or more network nodes is less than or equal to a third threshold.

In some examples: the first beam set comprises two beams each transmitted with one antenna port, wherein the first rank corresponds to an RI of 2; and the UE is further configured to:
indicate to the one or more network nodes that the second rank is achievable with one or more additional beams transmitted from the one or more network nodes; and
receive, from the one or more network nodes, one beam transmitted with two antenna ports or two beams each transmitted with one antenna port,
wherein the second beam set comprises the first beam set and the received one beam or the received two beams,
wherein the second rank associated with the obtained second beam set corresponds to an RI of 4.

In some examples: the first beam set comprises two beams each transmitted with two antenna ports, wherein the first rank corresponds to an RI lower than 4; and the UE is further configured to:
indicate to the one or more network nodes that the second rank, corresponding to an RI of 4, is achievable by switching to the second beam set different from the first beam set; and
receive the second beam set from the one or more network nodes, wherein the second beam set comprises at least one beam that is different from said two beams comprised in the first beam set.

In some examples, the one or more beams comprised in the second beam set are all different from at least one beam comprised in the first beam set.

In accordance with a second aspect of the present disclosure, there is provided a network node, configured in a cell serving a User Equipment, UE and configured to establish communication with the UE, the network node comprising:
at least one processor, and
at least one memory storing instructions that, when executed by the at least one processor, cause the network node at least to:
   schedule a first beam set for the communication with the UE, wherein the first beam set comprises one or more beams and reported UE measurement on the first beam set indicates a first rank associated with the scheduled first beam set;
   configure the UE to determine a second rank achievable by a second beam set, wherein the second rank is higher than the first rank and the second beam set comprises one or more beams;
   configure the UE to report the achievable second rank and the determined second beam set;
   receive from the UE an indication related to the determined second beam set; and
   transmit to the UE a switching command for scheduling the UE on the reported second beam set instead of the first beam set.

In some examples: the first beam set comprises one beam transmitted with two antenna ports, wherein the first rank corresponds to a Rank Indicator, RI, of 2; and the network node is configured to:
receive from the UE an indication to transmit to the UE a plurality of beam groups each comprising one or more beams for obtaining the second beam set;
transmit to the UE the plurality of beam groups;
configure the UE to perform measurement on the beams comprised in the plurality of beam groups for determining the second beam set associated with the achievable second rank higher than the first rank; and
receive from the UE an indication related to the determined second beam set determined by the UE among the plurality of beam groups.

In some examples: the first beam set comprises two beams each transmitted with one antenna port, wherein the first rank corresponds to an RI of 2; and the network node is further configured to:
receive from the UE an indication to add one or more beams to the first beam set for obtaining the achievable second rank;
based on the indication to add one or more beams, transmit to the UE one beam transmitted with two antenna ports or transmit to the UE two beams each transmitted with one antenna port, for obtaining the second beam set comprising the first beam set and the transmitted one beam or the transmitted two beams, wherein the second rank associated with the obtained second beam set corresponds to an RI of 4.

In some examples: the first beam set comprises two beams each transmitted with two antenna ports, wherein the first rank corresponds to an RI lower than 4; and the network node is further configured to:
receive from the UE an indication to switch to the second beam set that is different from the first beam set for achieving the second rank corresponding to an RI of 4; and
transmit to the UE the second beam set, wherein the second beam set comprises at least one beam that is different from said two beams comprised in the first beam set.

In some examples, the network node is configured to configure the UE to report at least one of the following:
the achievable second rank that is greater than or equal to a fourth threshold and/or that is lower than or equal to a fifth threshold,
other network nodes configured in said cell serving the UE,
a Transmit Configuration Index, TCI, state associated with each beam obtained at the UE, and
UE measurement on Channel State Information Reference Signal, CSI-RS, transmitted via each antenna port.

In some examples: the network node is configured to transmit to the UE a list of Synchronization Signal and Physical Broadcast Channel Block Resource Indicator, SSBRI, or CSI Reference Signal Resource Indicator, CRI, related to beams transmitted from the network node to the UE for the UE to perform measurement and determine the achievable second rank and the associated second beam set.

In accordance with a third aspect of the present disclosure, there is provided a communications system, comprising: a User Equipment, UE, in accordance with any one of the first aspect and its related examples; and one or more network nodes in accordance with any one of the second aspect and its related examples, wherein the one or more network nodes are configured in a cell serving the UE.

In accordance with a fourth aspect of the present disclosure, there is provided a method of a User Equipment, UE, configured to establish communication with one or more network nodes configured in a cell serving the UE, the method comprising:
determining a first rank associated with a first beam set scheduled by the one or more network nodes for the communication between the UE and the one or more network nodes,
wherein the first beam set comprises one or more beams;
reporting to the one or more network nodes that a second rank higher than the first rank is achievable by a second beam set, wherein the second beam set comprises one or more beams; and
receiving from the one or more network nodes a switching command to be scheduled on the reported second beam set instead of the first beam set.

In accordance with a fifth aspect of the present disclosure, there is provided a method of a network node, configured in a cell serving a User Equipment, UE and configured to establish communication with the UE, the method comprising:
scheduling a first beam set for the communication with the UE, wherein the first beam set comprises one or more beams and reported UE measurement on the first beam set indicates a first rank associated with the scheduled first beam set;
configuring the UE to determine a second rank achievable by a second beam set, wherein the second rank is higher than the first rank and the second beam set comprises one or more beams;
configuring the UE to report the achievable second rank and the determined second beam set;
receiving from the UE an indication related to the determined second beam set; and
transmitting to the UE a switching command for scheduling the UE on the reported second beam set instead of the first beam set.

In accordance with a sixth aspect of the present disclosure, there is provided a computer program comprising instructions for causing an apparatus to perform the method according to the fourth aspect, or for causing an apparatus to perform the method according to the fifth aspect.

In accordance with a seventh aspect of the present disclosure, there is provided a memory storing computer readable instructions for causing an apparatus to perform the method according to the fourth aspect, or for causing an apparatus to perform the method according to the fifth aspect.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a procedure that provides UE selected best RSRP beams but cannot maximize the rank;

FIG. 2 schematically illustrates an example of beam management procedures;

FIG. 3 schematically illustrates an example of event triggered measurement reporting based on rank optimization in DL for single-TRP scenario according to an example embodiment of the present disclosure;

FIG. 4 schematically illustrates an example of event triggered measurement reporting based on rank optimization in DL for multi-TRP scenario according to an example embodiment of the present disclosure; and

FIGS. 5A and 5B schematically illustrates examples of signaling diagrams for event triggered measurement reporting based on rank optimization according to an example embodiment of the present disclosure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

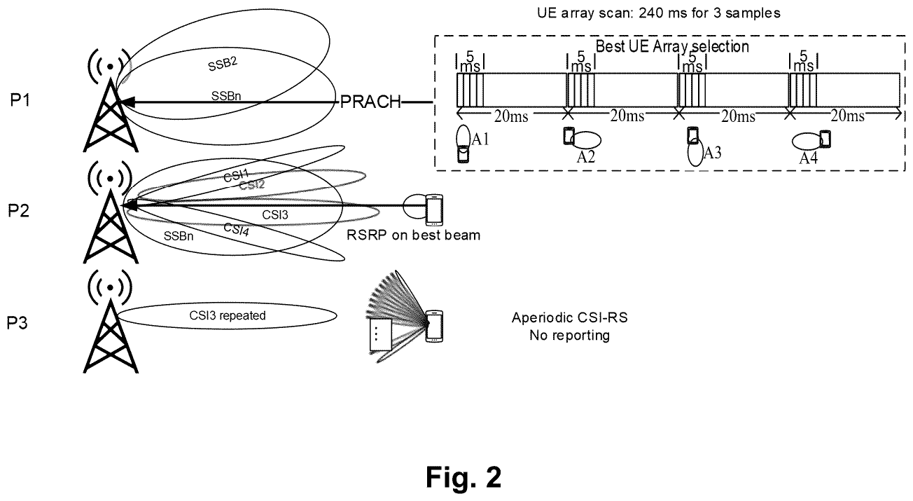

UE-initiated Beam Management: In Rel-15 to Rel-18 5G NR, the Beam management has been specified in 3 phases controlled by network: Phase #1 (P1), Phase #2 (P2) and Phase #3 (P3), as described in 3GPP in TS 38.214 section 5.1.5 (TCI and QCL framework) and 5.1.6 (CSI-RS reception procedures) and illustrated in FIG. 2. Furthermore, P1, P2 and P3 were specified according to 3GPP Rel15 Study Item of 5G NR [3GPP TR 38.802].

The following beam management procedures are supported within one or multiple TRPs (Transmit Receive Points) of the serving cell:
P1: is used to enable UE measurement on different TRP Tx beams to support selection of TRP Tx beams/UE Rx beam(s).
   For beamforming at TRP, it typically includes an intra/inter-TRP Tx beam sweep from a set of different beams. For beamforming at UE, it typically includes a UE Rx beam sweep from a set of different beams. UE may scan its antennas/panels sequentially for each SS burst and average over e.g. 3 samples.
P2: is used to enable UE measurement on different TRP Tx beams to possibly change inter/intra-TRP Tx beam(s).
   From a possibly smaller set of beams for beam refinement than in P1. Note that P2 can be a special case of P1. P2 may use narrower CSI beams compares to SSB beams.
P3: is used to enable US measurement on the same TRP Tx beam to change U Rx beam in the case where UR uses beamforming (e.g. mmW arrays on Us for FR2 operation). P3 typically uses aperiodic CSI-RS with ‘repetition’ flag ‘on’ and UE L-RSRP/SINR (Signal-to-Interference-plus-Noise Ratio) reporting is disabled.

The present disclosure focuses on reporting for P2.

In TS38.214, CSI-ResourceConfig specifies what type of reference signal (nzp-CSI-RS-SSB, csi-IM-Resource) is to be transmitted. It also configures the types ofthe transmission (periodic, aperiodic, semipersistent). The parameter reportConfigType indicates the scheduling method of the report. It can be periodic, aperiodic and semiPersistent as shown in the table below.

TABLE 1
Triggering/Activation of CSI Reporting for the possible CSI-RS Configurations

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by DCI; |
| CSI-RS | triggering/ | PUCCH, the UE | additionally, sub- |
| | activation | receives an activation | selection indication |
| | | command, as described | as described in |
| | | in Clause 6.1.3.16 of | clause 6.1.3.13 of |
| | | [10, TS 38.321]; for | [10, TS 38.321] |
| | | reporting on PUSCH, | possible as defined |
| | | the UE receives | in Clause 5.2.1.5.1. |
| | | triggering on DCI | |
| Semi- | Not supported | For reporting on | Triggered by DCI; |
| Persistent | | PUCCH, the UE | additionally, sub- |
| CSI-RS | | receives an activation | selection indication |
| | | command, as described | as described in |
| | | in Clause 6.1.3.16 of | clause 6.1.3.13 of |
| | | [10, TS 38.321]; for | [10, TS 38.321] |
| | | reporting on PUSCH, | possible as defined |
| | | the UE receives | in Clause 5.2.1.5.1. |
| | | triggering on DCI | |
| Aperiodic | Not supported | Not supported | Triggered by DCI; |
| CSI-RE | | | additionally, sub- |
| | | | selection indication |
| | | | as described in |
| | | | clause 6.1.3.13 of |
| | | | [10, TS 38.321] |
| | | | possible as defined |
| | | | in Clause 5.2.1.5.1. |

Rel-16 enables mTRP operation with simultaneous scheduling of PDSCH on two beams from two TRPs. Rel-18 is addressing the indication of two TCI (Transmit Configuration Index) states simultaneously in the unified TCI framework. In the scope of Rel-19 preparation, some use cases where UE could benefit from initiating the beam switch are being identified. Mostly the benefits are regarding the delays of CSI L1-RSRP/L1-SINR reporting and the overhead of the reporting. The clear advantages with UE triggered reporting are that the delays may be shorter between reports for a period of time to avoid e.g. failures and this event-triggered reporting is only transmitted when UE needs it (as opposed to increasing the periodicity of a periodic measurement report).

In view of the above, it is proposed in accordance with the present disclousure the following.

As a new event, the UE uses the correlation of the measured beams, hence the maximum achievable rank for simultaneous reception/transmission, to trigger a new report of the best beam pair. As such, if the current indicated beams for PDSCH and/or PUSCH are providing a smaller rank than another pair measured by the UE, then this constitutes an event and the new pair should be reported to network as an event-triggered beam reporting and UE-initiated beam pair switching; in addition to the (transmission/reception) beam pair, the UE may also be configured to report corresponding measurement such as achievable rank, RSRP, SINR, etc.

In one alternative embodiment, the reporting event may be triggered:
In case UE is reporting currently single beam(s) L1-RSRP results and the UE observed that the higher rank or data rate could be achieved via two simultaneous beams, the event is triggered to transmit indication for the gNB about the higher rank in multi-beam condition
   This may trigger at gNB to switch reporting from single-beam reporting to multi-beam/group based beam reporting
In case UE is reporting currently multi-beam/group based L1-RSRP results and the UE observed that the higher rank or data rate could be achieved via single beam only, the event is triggered to transmit indication for the gNB about the higher rank in single-beam condition
   This may trigger at gNB to switch reporting from group based beam reporting to single-beam beam reporting

The UE could be at least partly configured e.g., via RRC to perform the above-suggested triggering. The configuration may comprise one or more of: (min/max) rank the UE should consider for the above event or simply a condition that the achievable rank with a beam pair is higher than currently indicated rank (or previously reported rank), the quantity(ies) to report when the event occurs, TRPs or reference signals resources to consider, TCI (Transmit Configuration Index) states or TCI state groups to consider, etc.

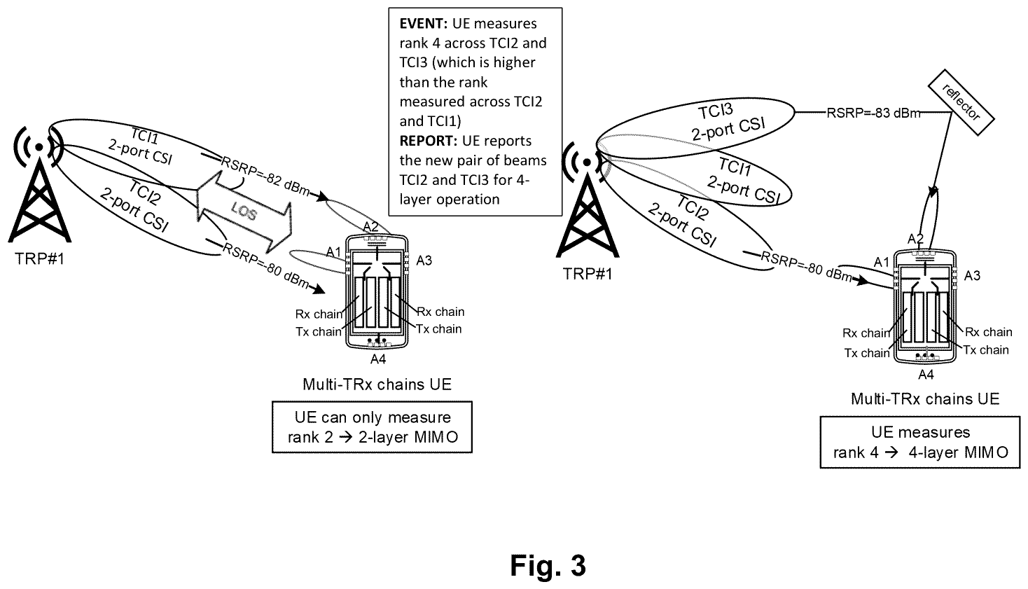

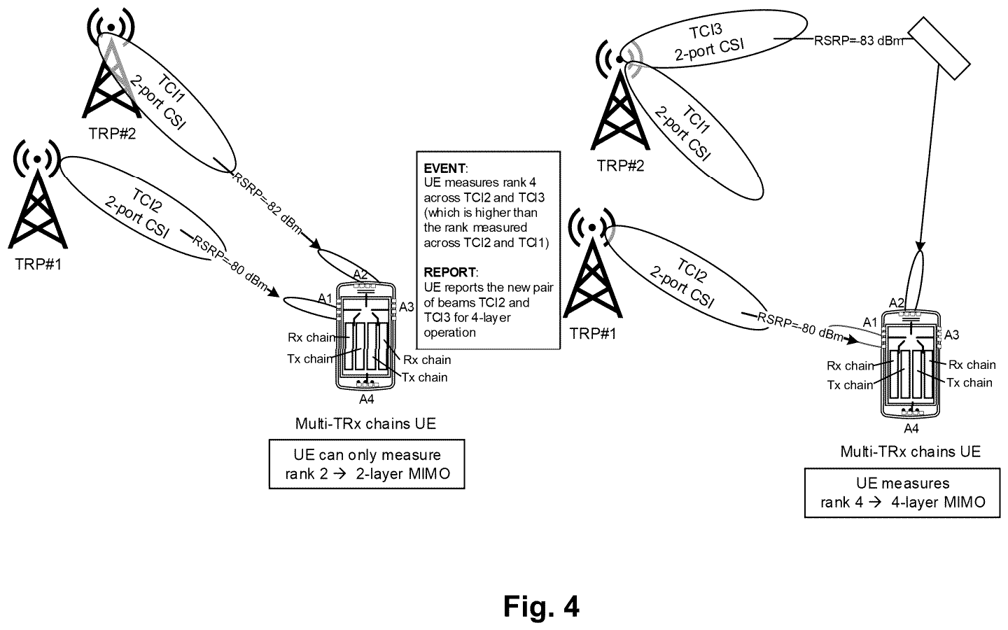

The above-described solution is illustrated in FIG. 3 and FIG. 4. In the example of FIG. 3, the single-TRP solution is illustrated. Nevertheless, the solution may be extended the multi-TRP scenario as illustrated in FIG. 4 and even to UL beam selection as well.

Current specifications focus on X-layer (e.g., X=4) DL scheduling across two TCJ states belonging to two TRPs. In this disclosure, we generalize the solution to more cases i.e., where for example 4-layer DL scheduling may also be configured on 2 TCI states originating from the same TRP or where 4 TCI states may be indicated. All these aspects are related to potential Rel-19 MIMO proposals and scope.

In summary, it is proposed in accordance with the present disclosure that the UE measurement of a higher rank than current rank constitutes the event which then triggers the UE beam reporting of the specific beam pair yielding this higher rank.

Therein, that the UE is able to detect a “better” beam pair (with “better” here taking into account the rank) than the currently selected beam pair from gNB because the UE is computing the correlation between the beams whereas the gNB only received power reports (RSRP and/or SINR).

A numerical example: With reference to FIG. 3, for example the UE is previously using two beams/TCI states (TCI1 and TCI2, that provides best RSRP, e.g., −80 and −82 dBm) and UE triggers the switch to a new pair (TCI2+TCI3, although RSRP of TC 3 is worse, e.g., −83 dBm as in FIG. 3) because that pair allows achieving a better rank.

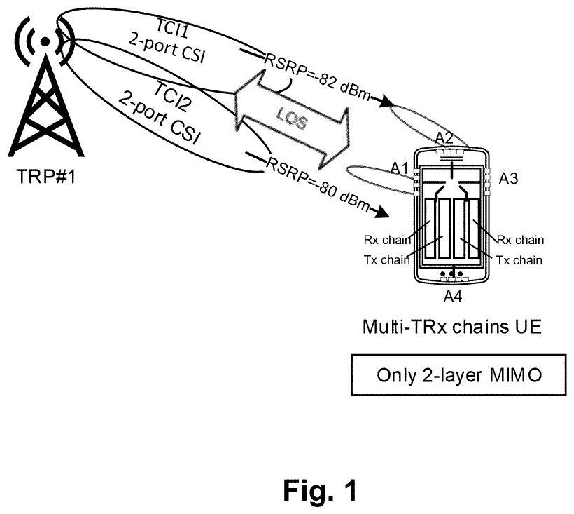

In comparison to the conventional techniques as shown e.g., in FIG. 1, the report of the beam set (SSBRI/CRI) is triggered by UE because of a higher rank is measured (as opposed to current periodic reporting on active TCI states).

The below use cases aim at UE triggering a TCI state addition or a pair of TCI states switch in order to maximize the rank, and therefore eventually throughput. The TCI states could come from or could correspond to one or multiple TRPs (a TRP may be represented by or correspond to a coresetPoolIndex, or an SRS resource set, or a DL reference signal (resource) set, in the specification).

In the present disclosure, a specific rank corresponds to a Rank Indicator (RI) that indicates the number of layers transmitted. For example, rank 1 corresponds to an RI of 1 indicating one layer, rank 2 corresponds to an RI of 2 indicating two layers, and rank 4 corresponds to an RI of 4 indicating 4 layers.

In the first case, UE is currently scheduled with 2 layers only and UE detects that it can go up to rank 4, i.e., 4 layers, with a specific beam pair, which it reports to the network (when configured for this). The use case is generalized to N groups of M beams, where the typical use case is N=4 and M=2, where each beam is a 2-port CSI-RS.

In the second case, UE is also currently scheduled with 2 layers only although these 2 layers come from two different TCI states. This would be the case of single-polarized antenna elements at the UE for example, where diversity cannot be achieved from polarization. As a result, to achieve rank 4, the UE needs to simultaneously receive 4 different TCI states (each of them carrying 1-port CSI RS). This use case can be seen as an example with M=4 where each beam is a 1-port CSI-RS.

In the third case, UE is already scheduled with 4 layers across 2 TCI states although throughput is low. UE can detect that if a different pair of beams was selected, beams would be better decorrelated, hence the maximum achievable throughput would be higher, although the individual received power level (e.g. L1-RSRP) of each of the new beams could be slightly lower than the one of the beams used for scheduling currently. Based on this, the UE triggers a beam pair report to switch one or both beams to the network.

For use case 3, the UE is connected to 2 beams but cannot reach the max rank. UE has detected another pair that could actually reach rank 4 which triggers the UE to report this new pair. Then, network switches to the new pair and schedules 4 layer transmission.

Case 1: UE is scheduled with 2 layers in FR2 with a 2-port CSI (i.e., 1 TCI state)
UE is already maximizing performance for the scenario with 2 layers;
UE could increase throughput by going to a scenario with 4 layers;
UE can inform network of the beam(s) to add to the currently scheduled TCI yielding the highest rank;
It is proposed in accordance with the present disclosure:
   gNB configures UE to report N beam groups of M beams where the individual RSRP/SINR level cannot be lower than a threshold (e.g. a relative threshold of x dB lower than the current best beam) and the rank is better than y (e.g. better than rank 2);
   gNB may put a condition that within the N beam groups, at least 1 group needs to contain at least one beam that is the current indicated TCI state;
   gNB may put a condition that within the N beam groups, at least 1 group may contain M beams where none of the M beams are the current indicated TCI state;
   gNB may put a condition that the beams belonging to the N beam groups may be associated to a maximum number of k TRPs;
   According to the above conditions and to the UE measurements, UE can inform network that a higher rank can be achieved by switching to a pair of beams that does not include the currently scheduled TCI, if it exists.

Case 2: UE is scheduled with 2 layers in FR2 with two 1-port CSI (i.e. 2 TCI states)
Note that this operation is currently only specified in mTRP but sTRP extension is also considered for this use case.
UE could increase throughput by going to a scenario with 4 layers. Note that this would require gNB to indicate 4 TCI states which may be an objective of Rel-19 for Coherent Joint Transmission (CJT).
It is proposed in accordance with the present disclosure:
   UE informs network whether it needs to add one 2-port CSI beam or two 1-port CSI beams to the current TCI state(s) in order to reach rank 4;
      Based on the UE indication, gNB schedules groups of 2 or 4 simultaneous DL RS and configures UE with N=2 or N=4.

Case 3: UE is scheduled with 4 layers in FR2 with two 2-port CSI (i.e. 2 TCI states)
UE is scheduled on CSI beams that were reported with highest RSRP, however rank is still low and throughput is not maximized e.g. in a LOS/single-ray environment.
It is proposed in accordance with the present disclosure: based on UE reporting a low rank (e.g. rank2 instead of expected rank4 across 2 TCI states) UE indicates to network that a higher rank can be achieved with a different pair of beams;
   such pair may be 2 different TCI states than the currently scheduled TCI states, in which case the network may switch the pair of beams,
      gNB needs to plan the coordination and switch commands for the pair across TRPs in mDCI mTRP scenario to reduce scheduling interruption;
   such pair may be constituting of one of the currently scheduled TCI states and a new one, in which case the network only needs to perform one TCI state switch,
      the UE may report the pair with CRI and reportquantity, or
      the UE may report only the new TCI to be added and point to the TCI index that needs to remain (among the 2 currently scheduled ones);
      coordination of the single beam switch while preserving DL scheduling on the remaining beam (no interruption in mDCI and DL throughput optimization).

Furthermore, gNB may provide UE with a list of SSBRI/CRI among which UE can measure correlation and trigger a beam pair switch if a higher rank is detected. As such, the search is reduced for UE and gNB remains in control of the beams where UE can trigger the beam pair switch.

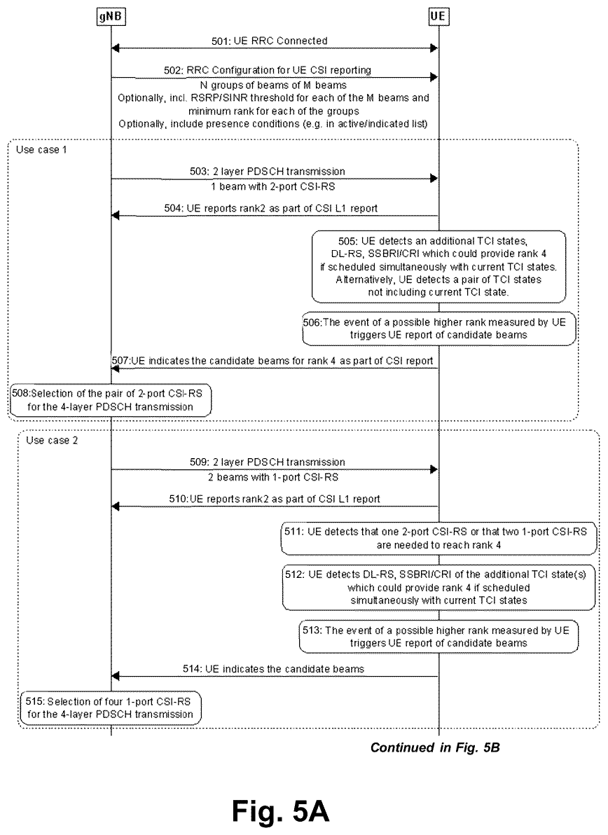

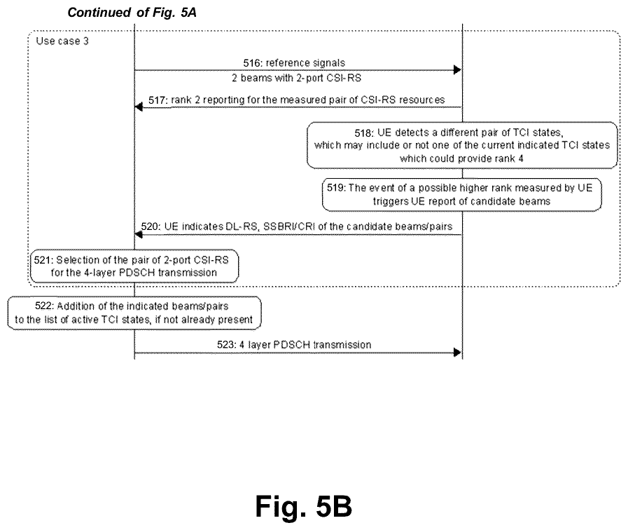

FIGS. 5A and 5B schematically illustrates examples of signaling diagrams for event triggered measurement reporting based on rank optimization in particular for the above three use cases.

As shown in FIGS. 5A and 5B, for all of the above three uses cases, it is proposed in accordance with the present disclosure:
Step 501: the UE is RRC connected to the gNB; and
Step 502: the gNB transmits to the UE an RRC configuration for UE CSI reporting, wherein with the RRC configuration it is indicated to the UE N groups of beams of M beams. Optionally, the RRC configuration includes RSRP/SINR threshold for each of the M beams and minimum rank for each of the groups. Optionally, the RRC configuration includes presence consitions (e.g., in active/indicated list).

Specifically, for the above first use case, as shown in FIGS. 5A and 5B, it is proposed in accordance with the present disclosure:
Step 503: the gNB performs a 2 layer PDSCH transmission and transmits to the UE 1 beam with 2-port CSI-RS;
Step 504: the UE reports rank 2 as part of CSI L1 report;
Step 505: UE detects an additional TCI states, DL-RS, SSBRI/CRI which provide rank 4 if scheduled simultaneously with current TCI states. Alternatively, UE detects a pair of TCI states not including current TCI state;
Step 506: the above event of possible higher rank measured by the UE triggers UE report of candicate beams;
Step 507: the UE indicates to the gNB the candidate beams for rank 4 as part of CSI report; and
Step 508: the gNB selects the pair of 2-port CSI-RS for the 4-layer PSDCH transmition.

Specifically, for the above second use case, as shown in FIGS. 5A and 5B, it is proposed in accordance with the present disclosure:
Step 509: the gNB performs a 2 layer PDSCH transmission and transmits to the UE 2 beams with 1-port CSI-RS;
Step 510: the UE reports rank 2 as part of CSI L1 report;
Step 511: the UE detects that one 2-port CSI-RS or that two 1-port CSI-RS are needed to reach rank 4;
Step 512: the UE detects DL-RS, SSBRI/CRI of the additional TCI state(s) which provide rank 4 if scheduled simultaneously with current TCI states;
Step 513: the above event of a possible higher rank measured by the UE triggers UE report of candicate beams;
Step 514: the UE indicates to the gNB the candidate beams; and
Step 515: the gNB selects four 1-port CSI-RS for the 4-layer PSDCH transmition.

Specifically, for the above third use case, as shown in FIGS. 5A and 5B, it is proposed in accordance with the present disclosure:
Step 516: the gNB transmits to the UE reference signals and 2 beams with 2-port CSI-RS;
Step 517: the UE performs rank 2 reporting for the measured pair of CSI-RS resources;
Step 518: the UE detects a difference pair of TCI states, which may include or not one of the current indicated TCI states and which provide rank 4;
Step 519: the above event of a possible higher rank measured by the UE triggers UE report of candicate beams;
Step 520: the UE indicates to the gNB DL-RS, SSBRI/CRI of the candidate beams/pairs;
Step 521: the gNB selects the pair of 2-port CSI-RS for the 4-layer PDSCH transmission;
Step 522: the gNB adds the indicated beams/pairs to the list of active TCI states, if not already present; and
Step 523: the gNB performs 4 layer PDSCH transmission.

It is noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

List of abbreviations:

| | |
|---|---|
| UE | User Equipment |
| RSRP | Reference Signal Received Power |
| CSI | Channel State Information |
| TCI | Transmit Configuration Index |
| DL RS | DownLink Reference Signal |
| PUCCH | Physical UpLink Control Channel |
| PUSCH | Physical UpLink Shared Channel |
| SRS | Sounding Reference Signal |
| RRC | Radio Resource Control |
| MAC CE | Medium Access Control Control Element |
| TRP | Transmit Receive Point |
| PCI | Physical Cell Id |
| SSB | Synchronization Signal Block |
| SSBRI | Synchronization Signal and Physical |
| | Broadcast Channel Block Resource Indicator |

1. A user equipment (UE) comprising:
at least one processor, and
at least one memory storing instructions that, when executed by the at least one processor, cause the UE at least to:
determine a first rank associated with a first beam set scheduled by one or more network nodes configured in a cell serving the UE for communication between the UE and the one or more network nodes, wherein the first beam set comprises one or more beams;
report to the one or more network nodes that a second rank higher than the first rank is achievable by a second beam set, wherein the second beam set comprises one or more beams; and
receive from the one or more network nodes a switching command to be scheduled on the reported second beam set instead of the first beam set.

2. The UE according to claim 1, wherein:
for a beam set comprising at least two beams, the UE is configured to determine a correlation between the at least two beams comprised in the beam set, wherein a higher correlation between said beams indicates a lower rank associated with said beam set.

3. The UE according to claim 1, wherein:
the first beam set comprises one beam transmitted with two antenna ports, wherein the first rank corresponds to a rank indicator (RI) of 2; and
the UE is configured to:
indicate the one or more network nodes to transmit a plurality of beam groups each comprising one or more beams for obtaining the second beam set;
receive, from the one or more network nodes, the plurality of beam groups;
perform measurement on the beams comprised in the plurality of beam groups; and
determine, among the plurality of beam groups based on the performed measurement, the second beam set associated with the achievable second rank higher than the first rank; and
report to the one or more network nodes the determined second beam set, wherein the reporting is triggered by the UE when the UE determines that the achievable second rank is higher than the first rank.

4. The UE according to claim 3, wherein:
the UE is configured to measure a reference signal received power (RSRP) or signal-to-interference-plus-noise ratio (SINR) value for each beam comprised in the plurality of beam groups, and the measured RSRP/SINR value for each beam is greater than or equal to a first threshold; and/or
the UE is configured to determine a rank associated with each beam group, and for each beam group the determined rank is greater than or equal to a second threshold.

5. The UE according to claim 3, wherein:
at least one beam group of said plurality of beam groups comprises at least one beam that is said one beam comprised in the first beam set; and/or
for at least one beam group of said plurality of beam groups, the one or more beams comprised in said at least one beam group are all different from said one beam comprised in the first beam set.

6. The UE according to claim 3, wherein the number of the one or more network nodes is less than or equal to a third threshold.

7. The UE according to claim 1, wherein:
the first beam set comprises two beams each transmitted with one antenna port, wherein the first rank corresponds to an RI of 2; and
the UE is further configured to:
indicate to the one or more network nodes that the second rank is achievable with one or more additional beams transmitted from the one or more network nodes; and
receive, from the one or more network nodes, one beam transmitted with two antenna ports or two beams each transmitted with one antenna port,
wherein the second beam set comprises the first beam set and the received one beam or the received two beams,
wherein the second rank associated with the obtained second beam set corresponds to an RI of 4.

8. The UE according to claim 1, wherein:
the first beam set comprises two beams each transmitted with two antenna ports, wherein the first rank corresponds to an RI lower than 4; and
the UE is further configured to:
indicate to the one or more network nodes that the second rank, corresponding to an RI of 4, is achievable by switching to the second beam set different from the first beam set; and
receive the second beam set from the one or more network nodes, wherein the second beam set comprises at least one beam that is different from said two beams comprised in the first beam set.

9. The UE according to claim 1, wherein the one or more beams comprised in the second beam set are all different from at least one beam comprised in the first beam set.

10. A network node comprising:
at least one processor, and
at least one memory storing instructions that, when executed by the at least one processor, cause the network node at least to:
schedule a first beam set for communication with a UE served in a cell in which the network node is configured, wherein the first beam set comprises one or more beams and reported UE measurement on the first beam set indicates a first rank associated with the scheduled first beam set;
configure the UE to determine a second rank achievable by a second beam set, wherein the second rank is higher than the first rank and the second beam set comprises one or more beams;
configure the UE to report the achievable second rank and the determined second beam set;
receive from the UE an indication related to the determined second beam set; and
transmit to the UE a switching command for scheduling the UE on the reported second beam set instead of the first beam set.

11. The network node according to claim 10, wherein:
the first beam set comprises one beam transmitted with two antenna ports, wherein the first rank corresponds to a rank indicator (RI) of 2; and
the network node is configured to:
receive from the UE an indication to transmit to the UE a plurality of beam groups each comprising one or more beams for obtaining the second beam set;
transmit to the UE the plurality of beam groups;
configure the UE to perform measurement on the beams comprised in the plurality of beam groups for determining the second beam set associated with the achievable second rank higher than the first rank; and
receive from the UE an indication related to the determined second beam set determined by the UE among the plurality of beam groups.

12. The network node according to claim 10, wherein:
the first beam set comprises two beams each transmitted with one antenna port, wherein the first rank corresponds to an RI of 2; and
the network node is further configured to:
receive from the UE an indication to add one or more beams to the first beam set for obtaining the achievable second rank;
based on the indication to add one or more beams, transmit to the UE one beam transmitted with two antenna ports or transmit to the UE two beams each transmitted with one antenna port, for obtaining the second beam set comprising the first beam set and the transmitted one beam or the transmitted two beams, wherein the second rank associated with the obtained second beam set corresponds to an RI of 4.

13. The network node according to claim 10, wherein:
the first beam set comprises two beams each transmitted with two antenna ports, wherein the first rank corresponds to an RI lower than 4; and
the network node is further configured to:
receive from the UE an indication to switch to the second beam set that is different from the first beam set for achieving the second rank corresponding to an RI of 4; and
transmit to the UE the second beam set, wherein the second beam set comprises at least one beam that is different from said two beams comprised in the first beam set.

14. The network node according to claim 10, wherein the network node is configured to configure the UE to report at least one of the following:
the achievable second rank that is greater than or equal to a fourth threshold and/or that is lower than or equal to a fifth threshold,
other network nodes configured in said cell serving the UE,
a transmit configuration index (TCI) state associated with each beam obtained at the UE, and
UE measurement on channel state information reference signal (CSI-RS) transmitted via each antenna port.

15. The network node according to claim 10, wherein
the network node is configured to transmit to the UE a list of synchronization signal and physical broadcast channel block resource indicator (SSBRI) or CSI-RS resource indicator (CRI) related to beams transmitted from the network node to the UE for the UE to perform measurement and determine the achievable second rank and the associated second beam set.

16. A method of a user equipment (UE) comprising:
determining a first rank associated with a first beam set scheduled by one or more network nodes configured in a cell serving the UE for communication between the UE and the one or more network nodes, wherein the first beam set comprises one or more beams;
reporting to the one or more network nodes that a second rank higher than the first rank is achievable by a second beam set, wherein the second beam set comprises one or more beams; and
receiving from the one or more network nodes a switching command to be scheduled on the reported second beam set instead of the first beam set.

17. The UE according to claim 16, wherein:
for a beam set comprising at least two beams, the UE is configured to determine a correlation between the at least two beams comprised in the beam set, wherein a higher correlation between said beams indicates a lower rank associated with said beam set.

18. The UE according to claim 16, wherein:
the first beam set comprises one beam transmitted with two antenna ports, wherein the first rank corresponds to a rank indicator (RI) of 2; and
the UE is configured to:
indicate the one or more network nodes to transmit a plurality of beam groups each comprising one or more beams for obtaining the second beam set;
receive, from the one or more network nodes, the plurality of beam groups;
perform measurement on the beams comprised in the plurality of beam groups; and
determine, among the plurality of beam groups based on the performed measurement, the second beam set associated with the achievable second rank higher than the first rank; and
report to the one or more network nodes the determined second beam set, wherein the reporting is triggered by the UE when the UE determines that the achievable second rank is higher than the first rank.

19. The UE according to claim 18, wherein:
the UE is configured to measure a reference signal received power (RSRP) or signal-to-interference-plus-noise Ratio (SINR) value for each beam comprised in the plurality of beam groups, and the measured RSRP/SINR value for each beam is greater than or equal to a first threshold; and/or
the UE is configured to determine a rank associated with each beam group, and for each beam group the determined rank is greater than or equal to a second threshold.

20. The UE according to claim 18, wherein:
at least one beam group of said plurality of beam groups comprises at least one beam that is said one beam comprised in the first beam set; and/or
for at least one beam group of said plurality of beam groups, the one or more beams comprised in said at least one beam group are all different from said one beam comprised in the first beam set.
